(19) United States
(12) Patent Application Publication
(10) Pub. No.: US 2024/0336223 A1
(43) Pub. Date: Oct. 10, 2024

(54) AUTOMATIC REMOTE IGNITION BLOCK IN HIGH CRIME ZONE

(71) Applicant: GM GLOBAL TECHNOLOGY OPERATIONS LLC, Detroit, MI (US)

(72) Inventors: Ali H. Fawaz, Dearborn Heights, MI (US); Robert Myers, Canton, MI (US); Ryan J. Baik, Troy, MI (US)

(73) Assignee: GM GLOBAL TECHNOLOGY OPERATIONS LLC, Detroit, MI (US)

(21) Appl. No.: 18/296,455

(22) Filed: Apr. 6, 2023

(51) Int. Cl. B60R 25/04; B60R 25/102; B60R 25/24; B60R 25/33; G06Q 50/26

(52) U.S. Cl. CPC B60R 25/04; B60R 25/102; B60R 25/24; B60R 25/33; G06Q 50/265; B60R 2025/0405

(57) ABSTRACT

Herein, a technology is discussed that facilitates the reduction of vehicle-related crime by disabling the use of a vehicle's engine when the vehicle is parked in a high-risk crime zone. The technology includes a method that sends a parked location of the vehicle to a data center and receives, from the data center, an indication to enable remote ignition block (RIB) of the vehicle when the parked location is part of a high-risk crime zone. In response, the vehicle enables RIB so that its engine will not start.

### INTRODUCTION

To curb the unauthorized use of the vehicle, some vehicles come equipped with technology to disable the ignition of its engine.

### SUMMARY

According to one embodiment, a method that includes detecting, by a vehicle, that the vehicle is parked; determining a location at which the vehicle is parked and sending the determined parked location to a data center; receiving, from the data center, an indication to enable remote ignition block (RIB) of the vehicle; notifying a user of the vehicle regarding reception of indication to enable RIB; receiving, from the user of the vehicle, an approval to enable the RIB of the vehicle; and in response to receiving the approval to perform the RIB of the vehicle, enabling RIB of the vehicle.

In this embodiment of the method, wherein the data center is, at least in part, located at a location selected from a group consisting of the vehicle, a mobile wireless device of the user, and a remote central data center, which is remote from the vehicle, and a combination thereof.

With this embodiment of the method, wherein the detection that the vehicle is parked includes detecting that the vehicle is stationary and in a defined parked gear.

With this embodiment, wherein the determining the parked location includes employing a global positioning system (GPS) to determine geolocation and/or employing cellular signal technology to determine a relative distance from one or more cellular stations.

In this embodiment of the method wherein sending the parked location to the data center includes employing a wireless transmission system to send the parked location to the data center.

In this embodiment of the method that further includes obtaining one or more crime rates associated with each zone of a plurality of zones in a region; assigning an RIB-enabled flag to zones having one or more crime rates above a defined threshold; receiving the parked location of the vehicle; identifying which zone includes the parked location of the vehicle; determining that the identified zone has an RIB-enabled flag; and in response to determining that the identified zone has an RIB-enabled flag, sending an indication to enable RIB of the vehicle.

In this embodiment of the method, wherein the notifying of the user of the vehicle regarding reception of indication to enable RIB includes employing special-purpose application on a wireless communication device.

According to yet another embodiment, a non-transitory machine-readable storage medium encoded with instructions executable by one or more processors that, when executed, direct one or more processors to perform operations that include detecting, by a vehicle, that the vehicle is parked; determining a location at which the vehicle is parked and sending the determined parked location to a data center; receiving, from the data center, an indication to enable remote ignition block (RIB) of the vehicle; and in response to receiving the indication to enable RIB, enabling RIB of the vehicle, thereby disabling ignition of an engine of the vehicle.

Another non-transitory machine-readable storage medium embodiment that includes additional operations: notifying a user of the vehicle regarding reception of indication to enable RIB; receiving, from the user of the vehicle, an approval to enable the RIB of the vehicle; and enabling RIB of the vehicle in response to both receiving the approval to perform the RIB of the vehicle and receiving the indication to enable RIB, thereby disabling ignition of an engine of the vehicle.

Another non-transitory machine-readable storage medium embodiment in which the data center is, at least in part, located at a location selected from a group consisting of the vehicle, a mobile wireless device of the user, and a remote central data center, which is remote from the vehicle, and a combination thereof.

Another non-transitory machine-readable storage medium embodiment in which the detection that the vehicle is parked includes detecting that the vehicle is stationary and in a defined parked gear.

Another non-transitory machine-readable storage medium embodiment in which the determining the parked location includes employing a global positioning system (GPS) to determine geolocation and/or employing cellular signal technology to determine a relative distance from one or more cellular stations.

Another non-transitory machine-readable storage medium embodiment in which the sending the parked location to the data center includes employing a wireless transmission system to send the parked location to the data center.

Another non-transitory machine-readable storage medium embodiment that includes receiving the parked location of the vehicle; identifying which zone of a plurality of zones in a region includes the parked location of the vehicle; determining that the identified zone has a flag to enable remote ignition block (RIB-enabled flag) associated therewith; and in response to determining that the identified zone has an RIB-enabled flag, sending an indication to enable RIB of the vehicle.

Another non-transitory machine-readable storage medium embodiment that includes obtaining one or more crime rates associated with each zone of a plurality of zones in a region; and assigning the RIB-enabled flag to zones having one or more crime rates above a defined threshold.

According to yet another embodiment, a method that includes obtaining one or more crime rates associated with each zone of a plurality of zones in a region; assigning a flag to enable remote ignition block (RIB-enabled flag) to zones having one or more crime rates above a defined threshold; receiving a parked location of a vehicle; identifying which zone includes the parked location of the vehicle; determining that the identified zone has an RIB-enabled flag; and in response to determining that the identified zone has an RIB-enabled flag, sending an indication to enable RIB of the vehicle.

Another embodiment of the method, in response to determining that the identified zone has an RIB-enabled flag, notifying a user of the vehicle regarding reception of indication to enable RIB.

Another embodiment of the method, the one or more crime rates is selected from a group consisting of vehicle-related crime, burglary of vehicles, vehicle theft, unauthorized use of a motor vehicle, carjacking, vehicle robbery, violent crime, burglary crime, traffic crime, murder and assault.

Another embodiment of the method that includes obtaining crime statistics, population, and demographic information associated with each zone of the plurality of zones in the region; and based on the obtained crime statistics, calculating the one or more crime rates associated with each zone of the plurality of zones in the region.

Another embodiment of the method that is configured to be performed by a data center is located, at least in part, on a group consisting of the vehicle, a mobile wireless device of the user, a remote central data center, which is remote from the vehicle, and a combination thereof.

The above features and advantages, and other features and advantages of the present teachings are readily apparent from the following detailed description of some of the best modes and other embodiments for carrying out the present teachings, as defined in the appended claims when taken in connection with the accompanying drawings.

### BRIEF DESCRIPTION OF THE DRAWINGS

FIG. 1 illustrates an example scenario of a parked vehicle performing security functions to reduce the risk of vehicle-related crimes, in accordance with one or more implementations described herein.

FIG. 2 illustrates an example of computer architecture for a computing system capable of executing the technology described herein.

FIG. 3 is a flowchart illustrating a process to perform an example method that facilitates the reduction of vehicle-related crime by disabling the use of a vehicle's engine when the vehicle is parked in a high-risk crime area, in accordance with one or more implementations described herein.

### DETAILED DESCRIPTION

The technology described herein facilitates the reduction of vehicle-related crime by disabling the use of a vehicle's engine when the vehicle is parked in a high-risk crime area.

Referring now to the drawings, wherein like numerals indicate like parts in the several views of various systems and approaches are shown and described herein. Disclosed approaches may be suitable for use with automotive vehicles, which include manual, autonomous, and semi-autonomous driving.

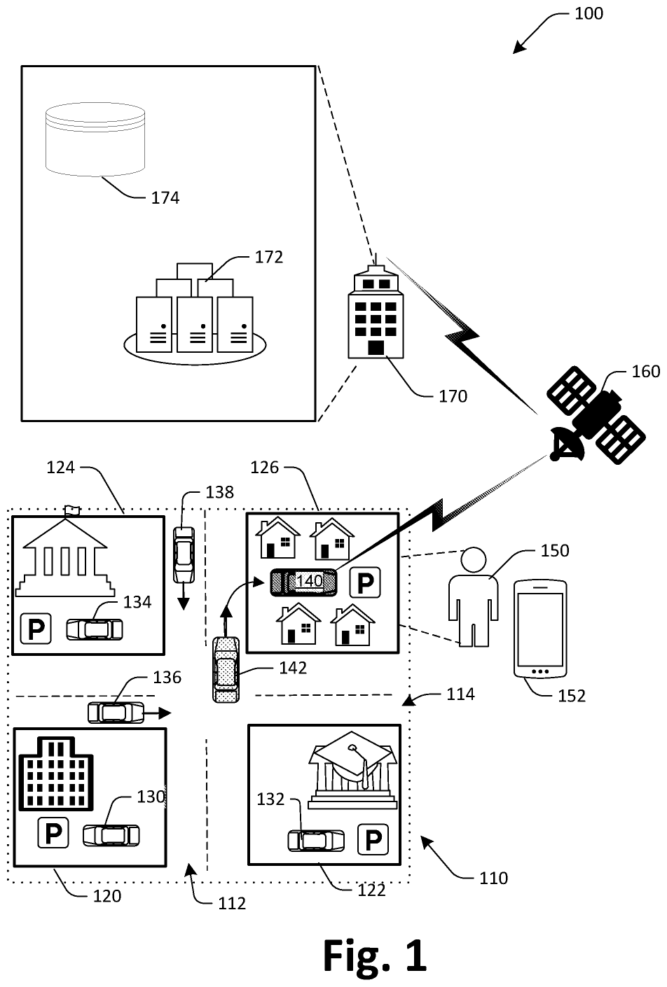

FIG. 1 illustrates an example scenario 100 that includes a map 110, a satellite 160, and a remote central data center 170, which are suitable for the implementation of the technology described herein. Map 110 depicts a geographic region that contains multiple geographic zones, such as zones 120, 122, 124, and 126. Such geographic zones may also be called areas, neighborhoods, and the like. In some instances, geographic zones may be mutually exclusive of each other. In other instances, the geographic zones may overlap.

As depicted in map 110, the zones are separated by intersecting roads 112 and 114. Sometimes, the roads may be part of their own zone or one or more zones. As shown by the forward arrow projecting from their front, automotive vehicles 136 and 138 are shown driving on roads 114 and 112, respectively. For the sake of simplicity in illustration, each zone is shown with a parking area labeled with a capital P in a rounded square. Zone 120 includes office buildings and has automotive vehicle 130 parked therein. Zone 122 includes an educational campus and has automotive vehicle 132 parked therein. Zone 124 includes governmental buildings and has automotive vehicle 134 parked therein. Zone 126 includes a neighborhood of houses and has parked vehicle 140 parked therein. Indeed, driving vehicle 142 is a past representation of parked vehicle 140. As depicted, the driving vehicle was moving along road 112 and turned left into zone 126 and ultimately parked (as shown by parked vehicle 140).

Once it comes to a stop, the parked vehicle 140 detects that it is no longer in motion (i.e., stationary) and that it has been placed into a parking “gear.” The vehicle may be placed into “park.” This is done by selecting “Park” or “P” with the gear selections. In doing so, the automatic transmission disconnects the engine from the transmission and locks the transmission with a pawl so that the transmission cannot turn while still connected to the wheels. In some instances, a parking brake may be engaged once parked. The parking brake is connected to the brake disks or drums and when engaged, restricts and/or prevents the wheels from turning. The parking brake is completely separate from the transmission. Herein, a defined parking gear includes one or more of the “Park” selection, pawl lock of the transmission, or the parking brake.

Once parked, the parked vehicle 140 determines its present location. That is, it determines the parked location. This may be accomplished via one or more available location technologies. Examples of such location technologies include a global positioning system (GPS), wireless proximity location technology (e.g., WI-FI™ (wireless fidelity), BLUETOOTH™ cellular triangulation location technology, mobile phone location sharing, and the like.

Parked vehicle 140 sends the determined parked location (e.g., 41° 24′12.2″N 2° 10′26.5″E) to the remote central data center 170. This wireless communication may include, for example, one or more of the following: satellite communications (as depicted by satellite 160), WI-FI™, BLUETOOTH™, cellular communications, radio communications, and/or Internet communications.

A user 150 may be a driver or passenger of the parked vehicle 140. The user 150 may have a mobile wireless device 152, such as a smartphone, tablet, computer, or the like. The mobile wireless device 152 may have a special-purpose application executing thereon that helps manage, remotely monitor, and remotely communicate with the parked vehicle 140 and/or with the remote central data center 170 regarding the parked vehicle 140.

Parked vehicle 140 has an engine for moving its wheels and thus the vehicle. Of course, first, the engine is started, which is often called ignition. Without engine ignition, the parked vehicle 140 will not move and, thus, will remain parked. Parked vehicle 140 includes an additional feature called remote ignition block (RIB). When the parked vehicle 140 receives the properly authorized RIB signal (such as, from the remote central data center 170), its engine ignition is disabled (thus, blocked). That is, RIB engagement disables engine ignition. Consequently, the parked vehicle 140 will not move on its own accord until RIB is disengaged.

Thus, if user 150 reports to the remote central data center 170 that the user's vehicle (which is parked vehicle 140) has been stolen, the remote central data center 170 may send a signal to that vehicle to enable RIB. As a result, the auto thief will be unable to start the engine of the parked vehicle 140.

The remote central data center 170 includes one or more computing systems 172 and one or more databases 174. While shown as one location in FIG. 1, the components and functionality of the remote central data center 170 may be distributed geographically and across multiple data centers. The “central” part of the name refers to the virtual appearance to vehicle 140 and/or user 150 on the mobile wireless device 152. The remote central data center 170 is remote or separate from the parked vehicle 140.

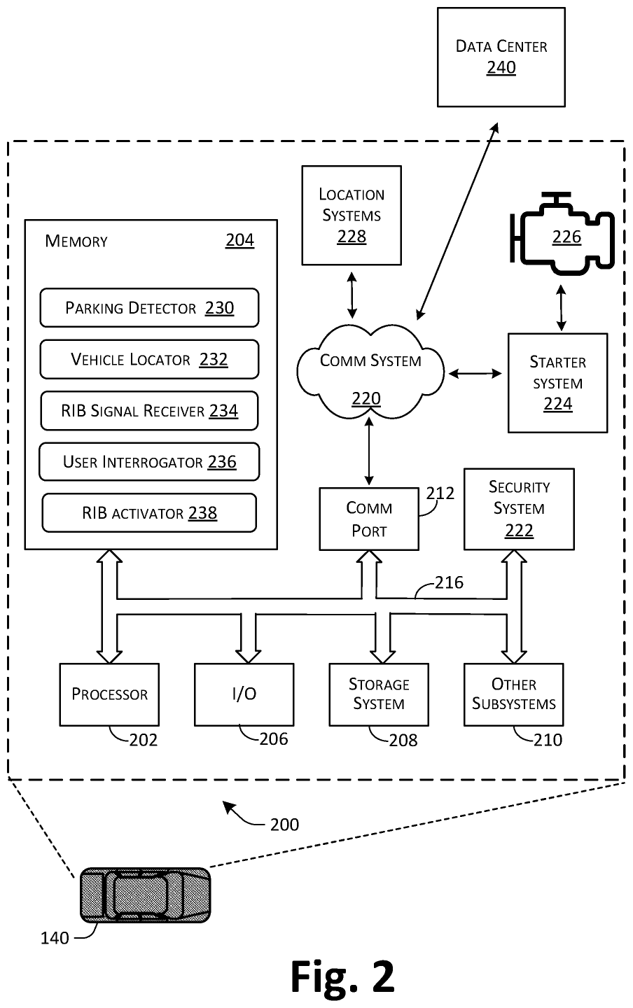

FIG. 2 illustrates an example of computer architecture for a computing system 200 capable of executing the technology described herein. The computer architecture shown in this figure illustrates a typical computer, server computer, workstation, desktop computer, laptop, tablet, network appliance, e-reader, smartphone, embedded system, or another computing device. Computer system 200 may be part of parked vehicle 140 and can be utilized to execute the functionalities presented herein.

The computing system 200 includes a processor 202 (e.g., central processor unit or “CPU”), system storage (e.g., memory) 204, input/output (I/O) devices 206-such as a display, a keyboard, a mouse, and associated controllers, a secondary storage system 208 (e.g., a hard drive), and various other subsystems 210. In various embodiments, the computing system 200 also includes communications (“comm”) port 212 operable to connect to a communications (“comm”) system 220. The computing system 200 may include or be connected to the vehicle security system 222, which manages the security of parked vehicle 140. The foregoing components may be interconnected via one or more buses 216 and/or communications system 220.

The communications system 220 enables internal communications within the parked vehicle 140 and external wireless communications, such as with the remote central data center 170. Internal communication may be, for example, via a local area network. The external wireless communication may include, for example, one or more of the following: satellite communications (as depicted by satellite 160), WI-FI™, BLUETOOTH™, cellular communications, radio communications, and/or Internet communications.

An engine starter system 224 is connected to an engine 226 of the parked vehicle 140 and performs the function of engine ignition. The engine starter system 224 may be connected to the computing system 200 via the communications system 220.

One or more location systems 228 may be connected to the computing system 200 via the communications system 220. Location systems 228 may employ one or more techniques to detect the present location of the vehicle. This may be done while the vehicle is moving or stationary. The location detection techniques may include, for example, a global positioning system (GPS), wireless proximity location technology (e.g., WI-FI™ (wireless fidelity), BLUETOOTH™, cellular triangulation location technology, mobile phone location sharing, and the like).

Data center 240 represents a remote central data center (such as remote central data center 170), An external data center, a local internal data center, or a combination thereof. The user's mobile wireless device 152 may be an example of an external data center. An on-board data system (e.g., components, storage, and processors) may be an example of a local internal data center. Indeed, the local internal data center may be another module running in system memory 204. Thus, in that instance, the local internal data center may use the same components as the computing system 200.

System memory 204 may store data and machine-readable instructions (e.g., computer-readable instructions). The computing system 200 may be configured by machine-readable instructions. Machine-readable instructions may include one or more instruction modules. The instruction modules may include computer program modules. The instruction modules may include one or more of a parking detector 230, a vehicle locator 232, a RIB signal receiver 234, a user interrogator 236, a RIB activator 238, and/or other instruction-based modules.

While the modules in the example depicted by this figure are implemented as modules using machine-readable instructions, other implementations of similarly functioning modules may be implemented using little to no machine-readable instructions. That is, such modules are implemented via hardware (e.g., circuitry) and analog and/or digital signals. In other instances, such modules may be implemented via a combination of hardware and machine-implemented instructions.

The parking detector 230 may be configured to detect that the vehicle is parked. Herein, a vehicle is parked when it is stationary and in parked gear. The vehicle may be placed into “park.” This is done by the user manually selecting “Park” or “P” with the gear selections. In doing so, the automatic transmission disconnects the engine from the transmission and locks the transmission with a pawl. In some instances, a parking brake may be engaged once parked. Herein, a defined parking gear includes one or more of the “Park” selection, pawl lock of the transmission, or the parking brake.

The vehicle locator 232 may be configured to determine the vehicle's present location based on information provided by one or more of the location systems 228. In some instances, the vehicle locator 232 may request the parked location from the location systems 228 in response to a parking state as detected by the parking detector 230. In other instances, the vehicle locator 232 periodically or continually receives location updates from the location systems 228. In that case, vehicle locator 232 takes the most recent location as the parked location. Once the parked location is determined, vehicle locator 232 sends the determined parked location to the data center 240 (which may include, for example, sending to the remote central data center 170 via the communication system 220).

The RIB signal receiver 234 may be configured to receive, from the data center 240, an indication to enable RIB of the vehicle. Of course, the signal will be authorized and recognized by an appropriate signal security system. This signal was generated by the data center 240 in response to a determination that the vehicle's parked zone exceeds a defined threshold of one or more crime rates.

User interrogator 236 may be configured to notify user 150 regarding the reception of indication to enable RIB. This notification may be via a special-purpose application on the mobile wireless device 152, SMS (short message service) message, email message, a secure website, and/or the like. User 150 specifies whether they approve the RIB enablement.

The RIB activator 238 may be configured to receive, from user 150, an approval to enable the RIB of the vehicle. In response to that approval, RIB activator 238 enables RIB of the vehicle. Consequently, engine 226 of parked vehicle 140 will not start.

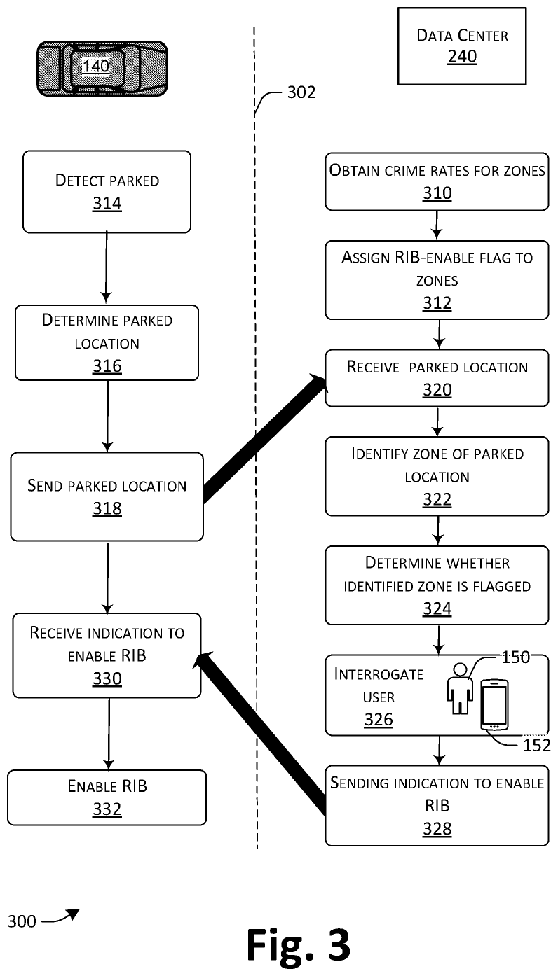

FIG. 3 is a flowchart that illustrates a process 300 to perform an example method that facilitates the reduction of vehicle-related crime by disabling the use of a vehicle's engine when the vehicle is parked in a high-risk crime area. For ease of illustration, process 300 may be described as being performed by a device or system described herein, such as vehicle 140 or the computing system 200 and/or by data center 240. However, process 300 may be performed by other devices or a combination of devices and systems.

As depicted, the operations listed to the left of a central dashed line 302 and under vehicle 140 are performed by the computing system 200 of vehicle 140. The operations listed to the right of the central dashed line 302 and under data center 240 are performed by the remote central data center, an external data center, a local internal data center, or a combination thereof. The user's mobile wireless device 152 may be an example of an external data center. An onboard data system (e.g., components, storage, and processors) may be an example of a local internal data center. Indeed, the local internal data center may be another module running in system memory 204. Thus, in that instance, the local internal data center may use the same components as computing system 200.

In some instances, the operations listed under vehicle 140 are performed by that vehicle, and operations listed under data center 240 are performed by the remote central data center 170. In still other instances, the listed operations may be performed by different and potentially other computer systems.

At operation 310, the data center obtains one or more crime rates associated with each zone of a plurality of geographic zones in a geographic region. One or more crime rates may be based on one or more relevant crimes, which is a crime determined relevant to vehicle-related crime. For example, relevant may include, for example, burglary of vehicles, vehicle theft, unauthorized use of a motor vehicle, carjacking, vehicle robbery, violent crime, burglary crime, traffic crime, murder, and assault. This operation may include obtaining crime statistics, population, and demographic information associated with each zone of the plurality of zones in the region. Then, based on the obtained crime statistics, the data center may calculate one or more crime rates associated with each zone of the plurality of zones in the region.

At operation 312, the data center assigns a RIB-enabled flag to zones having one or more crime rates above a defined threshold.

The defined threshold may be manually assigned, heuristically calculated, statistically determined, algorithmically determined, and/or determined by artificial intelligence tool (e.g., machine learning, deep learning, generative language model, large language model, etc.). The flag is a data field associated with a zone that is coded to indicate that one or more crime rates exceed the defined threshold. Thus, if a vehicle is located in a zone flagged with RIB-enabled, then the vehicle will receive an indication to enable RIB.

Meanwhile, at operation 314, the computing system of the vehicle detects that the vehicle is parked. In some instances, the computing system detects that the vehicle is parked by determining that the vehicle is stationary and in a defined parked gear.

At operation 316, the computing system determines the parked location. The determining of the parked location includes, for example, employing a global positioning system (GPS) to determine geolocation and/or employing cellular signal technology to determine a relative distance from one or more cellular stations.

At operation 318, the computing system sends (e.g., transmits) the determined parked location to the data center. The transmission of the parked location to the data center includes, for example, employing a wireless transmission system to send the parked location to the data center.

At operation 320, the data center receives the vehicle's parked location.

At operation 322, the data center identifies which zone includes the vehicle's parked location.

At operation 324, the data center determines whether the identified zone has a RIB-enabled flag. If not, then the data center may return to operation 320 to await the next parked location.

If so, then, at operation 328, the data center may interrogate the user (such as user 150) using, for example, a mobile device (like mobile wireless device 152). The interrogation may include notifying the user of the vehicle regarding the reception of the indication to enable RIB and awaiting the user's response. The interrogation may employ a special-purpose application on a wireless communication device (i.e., mobile wireless device 152). If the response is received from the user that is not an approval, then the data center may return to operation 320 to await the next parked location from the vehicle.

However, if an approval is received from the user, then, at operation 328, the data center sends an indication to enable the RIB of the vehicle.

At operation 330, the computing system of the vehicle receives the indication to enable the remote ignition block (RIB) of the vehicle.

At operation 332, the computing system of the vehicle enables RIB. Thus, the ignition of the engine is disabled.

In some implementations, the computing system of the vehicle rather than the remote data system performs the user interrogation of operation 326.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels and are not intended to impose numerical or positional requirements on their objects. As used herein, an element or step recited in the singular and preceded by the word “a” or “an” should be understood as not excluding the plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51% to 99% out of a possible extent of 100%”, and do not necessarily mean “perfectly”, “completely”, “strictly”, “entirely” or “100%”. Additionally, the word “proximate” may be used herein to describe the location of an object or portion thereof concerning another object or portion thereof, and/or to describe the positional relationship of two objects or their respective portions thereof concerning each other, and may mean “near”, “adjacent”, “close to”, “close by”, “at” or the like. And, the phrase “approximately equal to” as used herein may mean one or more of “exactly equal to”, “nearly equal to”, “equal to somewhere between 90% and 110% of” or the like.

This written description uses examples, including the best mode, to enable those skilled in the art to make and use devices, systems, and compositions of matter, and to perform methods, according to this disclosure. It is the following claims, including equivalents, which define the scope of the present disclosure.

What is claimed is:

1. A method comprising:
detecting that a vehicle is parked;
determining a location at which the vehicle is parked and sending the determined parked location to a data center;
receiving, from the data center, an indication to enable remote ignition block (RIB) of the vehicle;
notifying a user of the vehicle regarding reception of indication to enable RIB;
receiving, from the user of the vehicle, an approval to enable the RIB of the vehicle; and
in response to receiving the approval to perform the RIB of the vehicle, enabling RIB of the vehicle.

2. A method of claim 1, wherein the data center is, at least in part, located at a location selected from a group consisting of the vehicle, a mobile wireless device of the user, and a remote central data center, which is remote from the vehicle, and a combination thereof.

3. A method of claim 1 wherein the detection that the vehicle is parked includes detecting that the vehicle is stationary and in a defined parked gear.

4. A method of claim 1, wherein the determining of the parked location includes employing a global positioning system (GPS) to determine geolocation and/or employing cellular signal technology to determine a relative distance from one or more cellular stations.

5. A method of claim 1, wherein sending the parked location to the data center includes employing a wireless transmission system to send the parked location to the data center.

6. A method of claim 1 further comprising:
obtaining one or more crime rates associated with each zone of a plurality of zones in a region;
assigning a RIB-enabled flag to zones having one or more crime rates above a defined threshold;
receiving the parked location of the vehicle;
identifying which zone includes the parked location of the vehicle;
determining that the identified zone has an RIB-enabled flag; and
in response to determining that the identified zone has an RIB-enabled flag, sending an indication to enable RIB of the vehicle.

7. A method of claim 1, wherein the notifying of the user of the vehicle regarding reception of indication to enable RIB includes employing a special-purpose application on a wireless communication device.

8. A non-transitory machine-readable storage medium encoded with instructions executable by one or more processors that, when executed, direct the one or more processors to perform operations comprising:
detecting, by a vehicle, that the vehicle is parked;
determining a location at which the vehicle is parked and sending the determined parked location to a data center;
receiving, from the data center, an indication to enable remote ignition block (RIB) of the vehicle; and
in response to receiving the indication to enable RIB, enabling RIB of the vehicle, thereby disabling ignition of an engine of the vehicle.

9. A non-transitory machine-readable storage medium of claim 8, wherein the operations further comprise:
notifying a user of the vehicle regarding reception of indication to enable RIB;
receiving, from the user of the vehicle, an approval to enable the RIB of the vehicle; and
enabling RIB of the vehicle in response to both receiving the approval to perform the RIB of the vehicle and receiving the indication to enable RIB, thereby disabling ignition of an engine of the vehicle.

10. A non-transitory machine-readable storage medium of claim 8, wherein the data center is located, at least in part, on a group consisting of the vehicle, a mobile wireless device of the user, a remote central data center, which is remote from the vehicle, and a combination thereof.

11. A non-transitory machine-readable storage medium of claim 8, wherein the detection that the vehicle is parked includes detecting that the vehicle is stationary and in a defined parked gear.

12. A non-transitory machine-readable storage medium of claim 8, wherein the determining of the parked location includes employing a global positioning system (GPS) to determine geolocation and/or employing cellular signal technology to determine a relative distance from one or more cellular stations.

13. A non-transitory machine-readable storage medium of claim 8, wherein sending the parked location to the data center includes employing a wireless transmission system to send the parked location to the data center.

14. A non-transitory machine-readable storage medium of claim 8, wherein the operations further comprise:
receiving the parked location of the vehicle;
identifying which zone of a plurality of zones in a region includes the parked location of the vehicle;
determining that the identified zone has a flag to enable remote ignition block (RIB-enabled flag) associated therewith; and
in response to determining that the identified zone has an RIB-enabled flag, sending an indication to enable RIB of the vehicle.

15. A non-transitory machine-readable storage medium of claim 14, wherein the operations further comprise:
obtaining one or more crime rates associated with each zone of a plurality of zones in a region; and
assigning the RIB-enabled flag to zones having one or more crime rates above a defined threshold.

16. A method comprising:
obtaining one or more crime rates associated with each zone of a plurality of zones in a region;
assigning a flag to enable remote ignition block (RIB-enabled flag) to zones having one or more crime rates above a defined threshold;
receiving a parked location of a vehicle;
identifying which zone includes the parked location of the vehicle;
determining that the identified zone has a RIB-enabled flag; and
in response to determining that the identified zone has a RIB-enabled flag, sending an indication to enable RIB of the vehicle.

17. A method of claim 16 further comprising, in response to determining that the identified zone has a RIB-enabled flag, notifying a user of the vehicle regarding reception of indication to enable RIB.

18. A method of claim 16, wherein one or more crime rates is selected from a group consisting of vehicle-related crime, burglary of vehicles, vehicle theft, unauthorized use of a motor vehicle, carjacking, vehicle robbery, violent crime, burglary crime, traffic crime, murder, and assault.

19. A method of claim 16 further comprising:
obtaining crime statistics, population, and demographic information associated with each zone of the plurality of zones in the region;
based on the obtained crime statistics, calculating the one or more crime rates associated with each zone of the plurality of zones in the region.

20. A method of claim 17 that is configured to be performed by a data center is located, at least in part, on a group consisting of the vehicle, a mobile wireless device of the user, a remote central data center, which is remote from the vehicle, and a combination thereof.
